(19) United States
(12) Patent Application Publication
(10) Pub. No.: US 2020/0172701 A1
(43) Pub. Date: Jun. 4, 2020

(54) CURABLE SILICONE RUBBER MIXTURE, ELECTROPHOTOGRAPHIC MEMBER, AND ELECTROPHOTOGRAPHIC IMAGE FORMING APPARATUS

(71) Applicant: CANON KABUSHIKI KAISHA, Tokyo (JP)

(72) Inventors: Toshio Tanaka, Yokohama-shi (JP); Yasutomo Tsuji, Utsunomiya-shi (JP)

(21) Appl. No.: 16/692,031

(22) Filed: Nov. 22, 2019

(30) Foreign Application Priority Data
Nov. 29, 2018 (JP) 2018-224158
Nov. 5, 2019 (JP) 2019-201063

(51) Int. Cl. C08K 5/19; C08K 3/36; C08K 5/5419; G03G 15/16

(52) U.S. Cl. CPC C08K 5/19; G03G 15/162; C08K 5/5419; C08K 3/36

(57) ABSTRACT

Provided is a curable silicone rubber mixture providing a cured silicone rubber having a small change in volume resistivity, even when a high voltage is applied for a long period of time. The curable silicone rubber mixture includes: a curable silicone rubber, a cation, an anion and metal oxide particles, the cation including a first cation having one or more carbon-carbon double bonds in a molecular thereof, the metal oxide particles having surfaces whose hydrophilization rate is 0.50 or more.

### BACKGROUND OF THE INVENTION

### Field of the Invention

The present disclosure relates to an electrophotographic member used in an electrophotographic image forming apparatus and a curable silicone rubber mixture.

### Description of the Related Art

Recently, an electrophotographic image forming apparatus has been required to form a high-quality electrophotographic image even on a recording medium having a non-smooth surface, such as cardboard and embossed paper weighing more than 300 g/m². However, when an electrophotographic image is formed on the surface of the recording medium having a non-smooth surface, a toner image may be insufficiently transferred to a concave portion of the surface of the recording medium. For this problem, it is effective to use an intermediate transfer belt having an electroconductive elastic layer containing rubber such as silicone rubber, which is excellent in following a surface shape of the recording medium (Japanese Patent Application Laid-Open No. 2015-52680).

Japanese Patent Application Laid-Open No. 2009-173922 discloses, as an electroconductive silicone rubber having a small variation in a volume resistivity in a semiconductive region and having low voltage dependency of volume resistivity, an electroconductive silicone rubber composition of the following (A) to (C), and an electroconductive roller including a cured product layer of the electroconductive silicone rubber composition.
(A) 100 parts by weight of thermocurable silicone rubber;
(B) 1 to 150 parts by weight of electroconductive carbon black;
(C) 0.05 to 1000 ppm of an ionic liquid in which an anionic component is bis(trifluoromethanesulfonyl) imide, a cation component is a cation having at least one alkenyl group, the ionic liquid is slightly water-soluble or water-insoluble and a liquid at 25° C., and a decomposition temperature is 220° C. or higher.

It has been found that in order to reliably transfer a toner image on an intermediate transfer belt to a concave portion of the recording medium having a non-uniform surface, it is effective to set a transfer voltage to be a high voltage such as 1,000 V.

Therefore, a change from an initial value of volume resistivity after applying a direct current voltage of 1000 V to an intermediate transfer belt including an electroconductive elastic layer made of a cured product of the electroconductive silicone rubber composition according to Japanese Patent Application Laid-Open No. 2009-173922 for 6 hours, was observed. As a result, a significant change in volume resistivity was observed.

### SUMMARY OF THE INVENTION

At least one aspect of the present disclosure is directed to providing a curable silicone rubber mixture providing a cured silicone rubber having a small change in volume resistivity, even when a high voltage such as 1,000 V is applied for a long period of time.

Further, at least one aspect of the present disclosure is directed to providing an electrophotographic member which contributes to stable formation of a high-quality electrophotographic image for a long period of time.

In addition, at least one aspect of the present disclosure is directed to providing an electrophotographic image forming apparatus which can stably form a high-quality electrophotographic image for a long period of time.

According to one aspect of the present disclosure, there is provided a curable silicone rubber mixture including a curable silicone rubber, a cation, an anion, and metal oxide particles, the cation including a first cation having one or more carbon-carbon double bonds in a molecular thereof, and the metal oxide particles having surfaces whose hydrophilization rate is 0.50 or more.

According to another aspect of the present disclosure, there is provided an electrophotographic member including a substrate and an elastic layer on the substrate, wherein the elastic layer includes a cured product of the curable silicone rubber mixture.

According to still another aspect of the present disclosure, there is provided an electrophotographic image forming apparatus including the electrophotographic member as an intermediate transfer member.

Further features of the present invention will become apparent from the following description of exemplary embodiments with reference to the attached drawings.

### BRIEF DESCRIPTION OF THE DRAWINGS

FIG. 1 is a schematic diagram illustrating an example of a full color electrophotographic image forming apparatus.

FIG. 2 is a schematic diagram of an electrophotographic member having an endless shape, according to an embodiment of the present disclosure.

### DESCRIPTION OF THE EMBODIMENTS

We assumed the reason why volume resistivity of an intermediate transfer belt using a cured product of an electroconductive silicone rubber composition according to Japanese Patent Application Laid-Open No. 2009-173922 is greatly changed by applying a high voltage for a long period of time, as follows.

That is, the electroconductivity of the cured product of the electroconductive silicone rubber composition according to Japanese Patent Application Laid-Open No. 2009-173922 is considered to be due to both electronic conduction by electroconductive carbon black and ion conduction by an ionic liquid. Here, as an electroconductive mechanism by an electroconductive carbon black, a so-called tunnel effect theory in which π electrons jump between carbon black particles, is known. This is consistent with the fact that electronic conductivity largely depends on a dispersion state of carbon black.

Then, the ionic liquid is considered to have some influence on transfer of charges between carbon black particles. When a high voltage is applied to the cured product as such, cations and anions constituting the ionic liquid gradually move in the cured product, and a position relative to carbon black particles changes. As a result, the volume resistivity of the cured product is considered to change.

A curable silicone rubber mixture according to an embodiment of the present disclosure includes a curable silicone rubber, a cation including a first cation having one or more carbon-carbon double bonds in a molecular structure, an anion, and metal oxide particles having surfaces whose hydrophilization rate is 0.50 or more.

The reason why it is difficult for a cured product of the curable silicone rubber mixture according to the present embodiment to change the volume resistivity even when a high voltage is applied, is considered to be that the first cation having a carbon-carbon double bond interacts with a hydroxyl group present on a hydrophilic surface of the metal oxide particles, so that mobility of cations is reduced, and it is difficult for uneven distribution of ions to occur even when a high voltage is applied.

[Curable Silicone Rubber Mixture]

A curable silicone rubber mixture according to the embodiment of the present disclosure includes a curable silicone rubber, a cation including a first cation having one or more carbon-carbon double bonds in a molecular structure, an anion, and metal oxide particles having a surface whose hydrophilization rate is 0.50 or more due to a hydroxyl group on the surface. Hereinafter, each component will be described in detail.

<Curable Silicone Rubber>

As the curable silicone rubber, an addition curing type liquid silicone rubber can be used. The addition curing type liquid silicone rubber contains the following components (a), (b), and (c):

(a) organopolysiloxane having an unsaturated aliphatic group;

(b) organopolysiloxane having active hydrogen bonded to a silicon atom; and

(c) a platinum compound as a crosslinking catalyst.

Examples of the organopolysiloxane having an unsaturated aliphatic group which is the component (a) include the following:
linear organopolysiloxane having both molecular ends represented by (R₁)₂R₂SiO_{1/2} and an intermediate unit represented by (R₁)₂SiO and R₁R₂SiO;
branched organopolysiloxane including R₁SiO_{3/2} or SiO_{4/2} in an intermediate unit.

Herein, R₁ represents an unsubstituted or substituted monovalent hydrocarbon group which does not contain an unsaturated aliphatic group and is bonded to a silicon atom in the above formula. Specific examples of the hydrocarbon group include the following:
alkyl groups (for example, a methyl group, an ethyl group, a propyl group, a butyl group, a pentyl group, a hexyl group, and the like);
aryl groups (a phenyl group, a naphthyl group, and the like).

Examples of substituents which the hydrocarbon group may have include halogen atoms such as a fluorine atom and a chlorine atom; alkoxy groups such as a methoxy group and an ethoxy group; a cyano group, and the like. Specific examples of a substituted hydrocarbon group include a chloromethyl group, a 3-chloropropyl group, a 3,3,3-trifluoropropyl group, a 3-cyanopropyl group, a 3-methoxypropyl group, and the like. Among these, preferably, 50% or more of R₁ is a methyl group, and more preferably, all R₁ is a methyl group, since synthesis and handling are easy and excellent heat resistance can be obtained.

Further, R₂ represents an unsaturated aliphatic group bonded to a silicon atom in the above formula. Examples of the unsaturated aliphatic group include a vinyl group, an allyl group, a 3-butenyl group, a 4-pentenyl group, and a 5-hexenyl group. Among these, a vinyl group is preferred since synthesis and handling are easy and a crosslinking reaction of the silicone rubber easily proceeds.

The organopolysiloxane having active hydrogen bonded to a silicon atom which is the component (b) is a crosslinking agent which forms a crosslinked structure by reacting with an unsaturated aliphatic group contained in the component (a), by catalysis of a platinum compound as the component (c). It is preferred that the number of active hydrogens bonded to a silicon atom in the component (b) is more than 3 on average in one molecule.

As an organic group bonded to a silicon atom in the organopolysiloxane having active hydrogen bonded to a silicon atom as the component (b), an unsubstituted or substituted monovalent hydrocarbon group containing no unsaturated aliphatic group which is the same as R₁ of the component (a), is exemplified. In particular, a methyl group is preferred as the organic group, since synthesis and handling are easy. A molecular weight of the organopolysiloxane having active hydrogen bonded to a silicon atom is not particularly limited.

Further, a viscosity of the component (b) at 25° C. is preferably 10 mm²/s or more and 100,000 mm²/s or less, and more preferably 15 mm²/s or more and 1,000 mm²/s or less.

When the viscosity of the organopolysiloxane at 25° C. is within the above range, the case in which the organopolysiloxane volatilizes during storage so that a desired degree of crosslinking and the physical properties of a molded article cannot be obtained does not happen, and synthesis and handling are facilitated so that it is easy to disperse the organopolysiloxane uniformly in the system.

A siloxane skeleton of the component (b) may be linear, branched, or cyclic, and a mixture thereof may be used. Particularly, a linear one is preferred, from a viewpoint of ease of synthesis. Further, in the component (b), the Si—H bond may be present in any siloxane unit in the molecule, but at least a part thereof is preferably in the siloxane unit of a molecular end such as a (R₁)₂HSiO_{1/2} unit.

The addition curing type liquid silicone rubber having an amount of the unsaturated aliphatic group of 0.1 mol % or more and 2.0 mol % or less is preferred, and that having an amount of the unsaturated aliphatic group of 0.2 mol % or more and 1.0 mol % or less is more preferred, with respect to 1 mol of silicon atom.

A hardness of the silicone rubber after curing is preferably 5 degrees or more and 80 degrees or less and more preferably 15 degrees or more and 60 degrees or less in Type A hardness.

As the component (c), a known platinum compound can be used.

<First Cation Having One or More Carbon-Carbon Double Bonds in a Molecular Structure>

Examples of the first cation having one or more carbon-carbon double bonds in a molecular structure include quaternary ammonium to which an allyl group is bonded, and specific examples thereof include a structure such as that of Structural Formula (1-1)

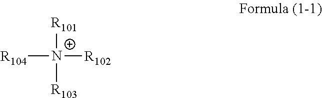

In Structural Formula (1-1), R₁₀₁ to R₁₀₄ independently of each other represent a group represented by Structural Formula (1-2) and one group selected from the group consisting of an alkyl group having 1 to 4 carbon atoms, but at least one of R₁₀₁ to R₁₀₄ is a group represented by Structural Formula (1-2).

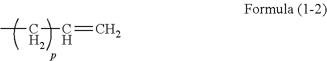

In Structural Formula (1-2), p represents an integer of 1 or more and 4 or less.

Further, the first cation may have phosphonium, sulfonium, or a cyclic structure, and examples of the cyclic structure include imidazolium, pyrrolidinium, piperidinium, pyridinium, and morpholinium.

The presence of the first cation in the silicone rubber mixture can be confirmed by immersing the cured silicone rubber mixture in a solvent such as acetone and extracting and analyzing the component eluted in the solvent. Examples of the analytical method include liquid chromatography mass spectroscopy and nuclear magnetic resonance spectrometry.

<Second Cation>

The cation may further include a second cation having a dimethylsiloxane chain.

In the curable silicone rubber mixture of the present disclosure, the metal oxide particles are present as a dispersed phase, in the continuous phase of the curable silicone rubber. Then, the first cation having one or more carbon-carbon double bonds in a molecular structure has a high affinity with a hydroxyl group on the surface of the metal oxide particles as a dispersed phase. On the other hand, since the second cation having a dimethylsiloxane chain has a chemical structure similar to the silicone rubber, it is considered that the affinity with the curable silicone rubber constituting a continuous phase is high.

Therefore, the curable silicone rubber mixture including the first cation and the second cation having a high affinity with each of the metal oxide particles constituting the dispersed phase and the curable silicone rubber constituting the continuous phase expresses more uniform electroconductivity. It is preferable that the second cation has a cation structure selected from the group consisting of quaternary ammonium, phosphonium, sulfonium, imidazolium, pyrrolidinium, piperidinium, pyridinium, and morpholinium.

A molar amount of the second cation to the first cation contributing to suppression of uneven distribution of ions by application of a high voltage is preferably an equal amount or less, and more preferably a ½ amount or less.

Hereinafter, a structure of the second cation will be described.

<Second Cation Having a Dimethylsiloxane Chain>

Examples of the second cation having a dimethylsiloxane chain include that to which quaternary ammonium and a dimethylsiloxane chain are bonded, as represented in Structural Formula (2-1). Further, the cation may have phosphonium as represented by Structural Formula (2-2), sulfonium, or a cyclic structure as represented by Structural Formula (2-3) and Structural Formula (2-4).

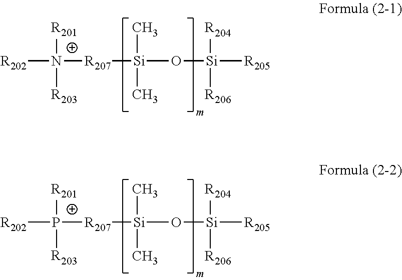

In Structural Formulae (2-1) and (2-2), R₂₀₁ to R₂₀₃ independently of each other represent a functional group such as a linear or branched alkyl group having 1 to 10 carbon atoms, an alkoxy group having 1 to 10 carbon atoms, a hydroxyl group, a benzyl group, or a carboxyl group. The functional group may be directly bonded to a nitrogen atom of quaternary ammonium, or may be bonded via an alkyl group or the like. Likewise, the functional group may be directly bonded to a phosphorous atom of the quaternary phosphonium, or may be bonded via an alkyl group or the like. It is preferred that R₂₀₁ to R₂₀₃ are a linear or branched alkyl group having 1 to 10 carbon atoms.

R₂₀₄ to R₂₀₆ independently of each other represent a linear or branched alkyl group having 1 to 10 carbon atoms, a hydroxyl group, an epoxy group, or a carboxyl group.

R₂₀₇ is a linking group between a dimethylsiloxane chain and a quaternary ammonium structure or a quaternary phosphonium structure. Examples of R₂₀₇ include a group obtained by a coupling reaction of a quaternary ammonium salt and polydimethylsiloxane. More specifically, examples of R₂₀₇ include a linear or branched alkylene group having 1 to 20 carbon atoms which may have a substituent. The alkylene group may have a structure via a group selected from the group consisting of -Ph-(phenylene), —O—, —C(═O)—, —C(═O)—O—, or —C(═O)—NR—(R represents an alkyl group having 1 to 6 carbon atoms). Examples of the substituent of the alkylene group may include a hydroxyl group.

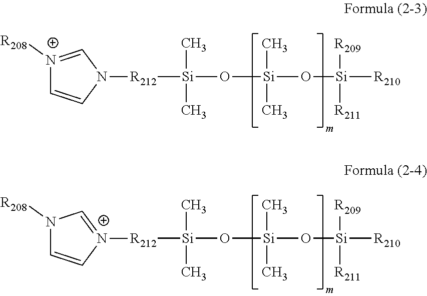

In Structural Formulae (2-3) and (2-4), R₂₀₈ represents an alkyl group having 1 to 10 carbon atoms (either linear or branched), an alkoxy group having 1 to 10 carbon atoms, a benzyl group, or a carboxyl group. It is preferred that R₂₀₈ is an alkyl group having 1 to 10 carbon atoms. R₂₀₉ to R₂₁₁ independently of each other represent an alkyl group having 1 to 10 carbon atoms (either linear or branched).

R₂₁₂ is a linking group between an imidazolium structure and a dimethylsiloxane chain. Examples of R₂₁₂ include a group obtained by a coupling reaction of an imidazolium salt and polydimethylsiloxane. More specifically, examples of R₂₁₂ include a linear or branched alkylene group having 1 to 20 carbon atoms which may have a substituent. The alkylene group may have a structure via a group selected from the group consisting of -Ph-(phenylene), —O—, —C(═O)—, —C(═O)—O—, or —C(═O)—NR—(R represents an alkyl group having 1 to 6 carbon atoms). Examples of the substituent of the alkylene group may include a hydroxyl group.

In Structural Formulae (2-1) to (2-4), a length of the dimethylsiloxane chain (m in the structural formula) is an integer of 1 or more and 150 or less, from a viewpoint of compatibility with silicone rubber.

<Anion>

The anion is not particularly limited.

Examples of available anion include at least one selected from the group consisting of AlCl₄⁻, Al₂Cl₇⁻, NO₃⁻, BF₄⁻, PF₆⁻, CH₃COO⁻, CF₃COO⁻, CF₃SO₃⁻, (CF₃SO₂)₃C⁻, AsF₆⁻, SbF₆⁻, F(HF)n⁻, CF₃CF₂CF₂CF₂SO₃⁻, (CF₃CF₂SO₂)₂N⁻, CF₃CF₂CF₂COO⁻, and (CF₃SO₂)₂N⁻. When used as the electrophotographic member, (CF₃SO₂)₂N⁻ (hereinafter, the bistrifluorosulfonylimide anion may be abbreviated as “TFSI⁻”) is more preferred, from a viewpoint that an influence by humidity is small.

In addition, each of the cation and the anion may be used alone or in combination of two or more.

The total amount of the anion and the cation including the first cation and the second cation, may preferably be 0.01 parts by mass or more, preferably 10 parts by mass or less, and particularly preferably 0.05 parts by mass or more and 5 parts by mass or less, with respect to 100 parts by mass of the cured silicone rubber. When the total amount of the anion and the cation including the first cation and the second cation is within the above range with respect to the addition curing type liquid silicone rubber, it is easy to adjust the volume resistivity of the cured product of the liquid silicone rubber mixture to the range of a medium resistance region such as 1.0×10⁸ Ω·cm to 2.0×10¹¹ Ω·cm (1.0 E+8 Ω·cm to 2.0 E+11 Ω·cm), by cooperation with the metal oxide particles having a hydroxyl group on the surface described later.

<Metal Oxide Particles Having Surfaces Whose Hydrophilization Rate is 0.50 or More>

The metal oxide particles having surfaces whose hydrophilization rate is 0.50 or more, are a component for adjusting the volume resistivity of the cured product of the curable silicone rubber to the above-described medium resistance region by ion conductivity.

Examples of the metal oxide particles as such include hydrophilic silica particles and hydrophilic alumina particles as shown below. Presence of the metal oxide particles in the silicone rubber mixture can be confirmed by extracting a solid content from the silicone rubber mixture and performing analysis by a near infrared spectroscopic analysis described later, or the like. In addition, when the silicone rubber mixture is liquid, it is diluted with a solvent such as toluene, and when the silicone rubber mixture is a cured product, it is dissolved in a soluble solvent (for example, trade name: eSolve 21RS, manufactured by Kaneko Chemical Co., Ltd.), respectively, and filtered through a filter to obtain a solid content.

<<Hydrophilic Silica Particles>>

The hydrophilic silica particles refer to silica particles having sufficiently hydrophilized surfaces. A degree of hydrophilicity of the surfaces of the silica particles can be evaluated by an analytical method such as near infrared spectrometry. Specifically, a near-infrared spectrum (IR spectrum) of the surface of silica particles is measured by a near-infrared spectroscopic apparatus (Frontier NIR, manufactured by PerkinElmer Co., Ltd.), and from the spectral data, a value calculated by dividing the absorbance at 7300 cm⁻¹ corresponding to Si—OH by the absorbance at 4500 cm⁻¹ corresponding to SiO₂ is defined as the hydrophilization rate, and it is possible to compare the amount of Si—OH present on the surface. The hydrophilic silica particles refers to that having surfaces whose hydrophilization rate calculated by the above method is 0.50 or more. The hydrophilization rate of the hydrophilic silica particles may preferably be 0.51 or more and 0.98 or less.

The silica particles are not particularly limited as long as they satisfy the hydrophilization rate, and the silica particles may be used alone or in combination of two or more.

<<Hydrophilic Alumina Particles>>

The hydrophilic alumina particles refer to alumina particles having sufficiently hydrophilized surfaces. The hydrophilization rate of the hydrophilic alumina can be evaluated by the same method as the above evaluation method of the hydrophilization rate of the silica particles. In the case of the hydrophilic alumina, a value calculated by dividing the absorbance at 3690 cm⁻¹ corresponding to Al—OH by the absorbance at 7425 cm⁻¹ corresponding to Al₂O₃ is defined as the hydrophilization rate of the hydrophilic alumina, and it is possible to compare the amount of Al—OH present on the surface. The hydrophilic alumina particles which can be preferably used have the hydrophilization rate calculated by the above method of 0.50 or more.

It is preferred that a blending amount of the metal oxide particles having surfaces whose hydrophilization rate is 0.50 or more, is 0.1 parts by mass or more and 30.0 parts by mass or less, and particularly 0.2 parts by mass or more and 5.0 parts by mass or less, with respect to 100 parts by mass of the curable silicone rubber. When the amount of the metal oxide particles having a hydroxyl group on the surface relative to the curable silicone rubber is within the above range, the volume resistivity of the cured product of the curable silicone rubber mixture can be easily adjusted to the medium resistance region. Further, when a high voltage is applied to the cured product, a fluctuation in the volume resistivity can be more reliably suppressed. Furthermore, the viscosity of the curable silicone rubber mixture can be suppressed from becoming too high.

<Electronic Conductive Agent>

It is also considered that there is a hydroxyl group on the surface of electroconductive carbon black contained in the electroconductive silicone rubber composition according to Japanese Patent Application Laid-Open No. 2009-173922, and a part of the cation having at least one alkenyl group is captured by the carbon black. However, it can be said that the electroconductivity of the electroconductive silicone rubber composition according to Japanese Patent Application Laid-Open No. 2009-173922 is dominated by electron of the carbon black, since an amount of the ionic liquid added is very small, which is 0.05 to 1000 ppm. In this case, even though cation movement under high voltage application is suppressed by the carbon black, cation movement is not completely suppressed, and thus, the position of ions to the carbon black varies, and as a result, it is considered that a large fluctuation in the volume resistivity occurs.

Therefore, it is preferred that the curable silicone rubber mixture according to the present embodiment is free of the electronic conductive agent such as electroconductive carbon black. Further, even in the case of including the electronic conductive agent, it is preferred to include the electronic conductive agent in an amount which hardly causes electronic conduction, for example, the content of the electronic conductive agent may preferably be 0.1% by mass or less, with respect to the total amount of the curable silicone rubber mixture.

Examples of the electronic conductive agent include electroconductive carbon black such as acetylene black and ketjen black, graphite, graphene, carbon fiber, carbon nanotubes, metal powder such as silver, copper, and nickel powder, electroconductive zinc flower, electroconductive calcium carbonate, electroconductive titanium oxide, electroconductive tin oxide, and electroconductive mica.

<Additive>

In addition to the above, the elastic layer may include an additive such as a filler, a crosslinking accelerator, a crosslinking retarder, a crosslinking aid, a colorant, an anti-scorch agent, an anti-aging agent, a softening agent, a thermal stabilizer, a flame retardant, a flame retardant aid, an ultraviolet absorber, and a rust inhibitor.

[Electrophotographic Member]

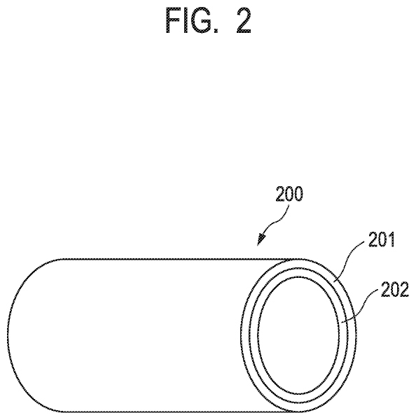

Next, the electrophotographic member will be described. FIG. 2 is a schematic diagram of an electrophotographic member (hereinafter, also referred to as an “electrophotographic belt”) 200 having an endless shape according to the embodiment of the present disclosure. The electrophotographic belt 200 is composed of an endless substrate 202 and an elastic layer 201 formed on the circumferential surface. In addition, if necessary, a surface layer (not illustrated) can be further provided on the circumferential surface of the elastic layer 201.

<Elastic Layer>

The elastic layer includes a cured product of the above-described curable silicone rubber mixture.

The elastic layer can be formed on a substrate by performing application of the above-described curable silicone rubber mixture on the substrate having a cylindrical shape, a columnar shape, or endless belt shape and curing. The thickness of the elastic layer can be appropriately adjusted in a range satisfying the function as the electrophotographic member. In particular, the elastic layer for an intermediate transfer belt has a thickness of preferably 80 μm to 600 μm, and more preferably 150 μm or more and 400 μm or less, from a viewpoint of suppressing color shift of a toner image on the surface of the intermediate transfer belt.

<Substrate>

As the substrate, a substrate having a cylindrical shape, a columnar shape, or an endless belt shape can be used, corresponding to a shape of the electrophotographic member. The material of the substrate is not particularly limited, as long as it is a material having excellent thermal resistance and mechanical strength. Examples thereof include metals such as aluminum, iron, copper, and nickel, alloys such as stainless steel and brass, alumina, ceramics such as silicon carbide, and resins such as polyetheretherketone, polyethylene terephthalate, polybutylene naphthalate, polyester, polyimide, polyamide, polyamideimide, polyacetal, and polyphenylene sulfide.

In addition, when the resin as a material of the substrate is used, metal powder, and electroconductive powder such as electroconductive oxide powder and electroconductive carbon may be added to impart electroconductivity.

As the material of the substrate, a resin having excellent flexibility and mechanical strength is particularly preferred, and among these, polyetheretherketone containing carbon black as electroconductive powder and polyimide containing carbon black as electroconductive powder are particularly preferably used. Further, the thickness of the endless shaped substrate is for example, 10 μm or more and 500 μm or less, particularly 30 μm or more and 150 μm or less.

In order to bond the substrate and the elastic layer more firmly, a primer may be appropriately applied on the outer surface of the substrate. The primer used herein is a paint in which a silane coupling agent, a silicone polymer, hydrogenated methylsiloxane, alkoxysilane, a reaction accelerating catalyst, and a colorant such as bengala are appropriately blended and dispersed in an organic solvent. As the primer, commercial products can be used. A primer treatment is performed by applying the primer to the outer surface of the substrate, and drying or baking it. The primer can be appropriately selected depending on the material of the substrate, the type of the elastic layer, or the form of the crosslinking reaction. In particular, when the elastic layer contains a large amount of the unsaturated aliphatic group, in order to impart an adhesive property by a reaction with the unsaturated aliphatic group, a primer containing a hydrosilyl group is preferably used. Examples of a commercially available primer having such characteristics include DY39-051A/B (Dow Corning Toray Co., Ltd.).

Further, when the elastic layer contains many hydrosilyl groups, a primer containing an unsaturated aliphatic group is preferably used. Examples of a commercially available primer having such characteristics include DY39-067 (Dow Corning Toray Co., Ltd.). Examples of the primer other than the above include a primer containing an alkoxy group. Further, by subjecting the substrate surface to a surface treatment such as ultraviolet irradiation, a crosslinking reaction between the substrate and the elastic layer can be assisted and adhesive strength can be further increased. Further, examples of the primer other than the above include X-33-156-20, X-33-173A/B, X-33-183A/B (Shin-Etsu Chemical Co., Ltd.), DY39-90A/B, DY39-110A/B, DY39-125A/B, DY39-200A/B (Dow Corning Toray Co., Ltd.), and the like.

<Surface Layer>

The surface layer of the electrophotographic member is required to be resistant to wear caused by rubbing against a recording medium such as paper and various abutting members such as a drum, and to have low adhesion so that toner or the like is not fixed. The resin used in the surface layer is not particularly limited as long as it has low adhesion, but examples thereof include a fluorine resin, a fluorine-containing urethane resin, a fluorine rubber, and siloxane-modified polyimide. As the surface layer for the intermediate transfer belt, among these, a fluorine-containing urethane resin is preferred, from a viewpoint of not impairing the elastic function of the elastic layer.

A thickness of the surface layer is preferably 0.5 μm or more and 20 μm or less, and more preferably 1 μm or more and 10 μm or less. When the thickness of the surface layer is 0.5 μm or more, it is easy to suppress a loss of toner due to wear of the surface layer during use. Further, when the thickness of the surface layer is 20 μm or less, the elastic function of the elastic layer is not impeded.

The surface layer may contain the electronic conductive agent described above, as needed. It is preferred that a content of the electronic conductive agent in the surface layer is 30 parts by mass or less, with respect to the surface layer, from a viewpoint of adhesion and mechanical strength.

Further, a primer layer may be provided between the elastic layer and the surface layer, as needed. A thickness of the primer layer is preferably 0.1 μm or more and 15 μm or less, and more preferably 0.5 μm or more and 10 μm or less, from a viewpoint of not impeding the elastic function.

<Electrophotographic Image Forming Apparatus>

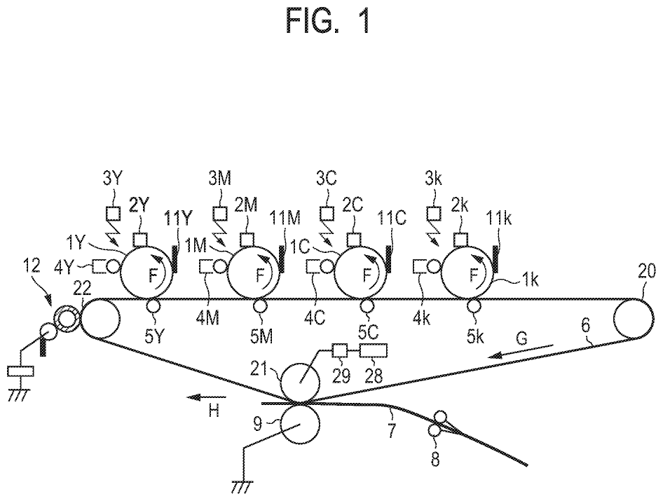

The electrophotographic image forming apparatus according to an embodiment of the present disclosure includes the above-described electrophotographic endless belt according to the present embodiment as the intermediate transfer member (intermediate transfer belt). An example of the embodiment of the electrophotographic image forming apparatus will be described with reference to FIG. 1. The image forming apparatus of the present embodiment has a so-called tandem configuration, in which image forming stations of a plurality of colors are arranged side by side in a rotation direction of the electrophotographic endless belt (hereinafter, referred to as “intermediate transfer belt”). In addition, in the following description, subscripts of Y, M, C, and k are added to the configuration signs regarding each color of yellow, magenta, cyan, and black, respectively, but the subscripts may be omitted for the same configuration.

The signs of FIGS. 1, 1Y, 1M, 1C, and 1k are photosensitive drums (photosensitive member, image carrier), and around a photosensitive drum 1, charging units 2Y, 2M, 2C, and 2k, exposing units 3Y, 3M, 3C, and 3k, developing units 4Y, 4M, 4C, and 4k, and an intermediate transfer belt (intermediate transfer member) 6 are disposed. The photosensitive drum 1 is rotationally driven in a direction of an arrow F at a predetermined circumferential speed (process speed). The charging unit 2 charges a peripheral surface of the photosensitive drum 1 to predetermined polarity and potential (primary charging). A laser beam scanner as the exposing unit 3 outputs on/off modulated laser light corresponding to image information input from external devices (not illustrated) such as an image scanner and a computer, and subjects a charge-treated surface on the photosensitive drum 1 to scanning exposure. By the scanning exposure, an electrostatic latent image to be desired corresponding to the image information is formed on the surface of the photosensitive drum 1.

The developing units 4Y, 4M, 4C, and 4k enclose toner of each color component of yellow (Y), magenta (M), cyan (C), and black (k), respectively. Then, the developing unit 4 to be used is selected based on the image information, the developer (toner) is developed on the surface of the photosensitive drum 1, and the electrostatic latent image is visualized as a toner image. In the present embodiment, a reversal development method in which toner is attached to the exposed portion of the electrostatic latent image as such, is used. Further, image forming units is constituted by the charging unit, the exposing unit, and the developing units as such.

Further, the intermediate transfer belt 6 is the electrophotographic endless belt according to the present embodiment, is arranged so as to abut on the surface of the photosensitive drum 1, and is stretched around a plurality of stretching rollers 20, 21, and 22. Then, the intermediate transfer belt 6 moves rotationally in a direction of an arrow G. In the present embodiment, the stretching roller 20 is a tension roller which controls a tension of the intermediate transfer belt 6 to be constant, the stretching roller 22 is a driving roller for the intermediate transfer belt 6, and the stretching roller 21 is a counter roller for secondary transfer. Further, primary transfer rollers 5Y, 5M, 5C, and 5k are disposed at primary transfer positions opposing the photosensitive drum 1 with the intermediate transfer belt 6 interposed therebetween, respectively. Each color unfixed toner image formed on the photosensitive drum 1 is subsequently electrostatically primary-transferred onto the intermediate transfer belt 6, by applying a primary transfer bias having an opposite polarity (for example, positive polarity) to a toner charge polarity by a constant voltage source or a constant current source to a primary transfer roller 5. Then, four-color unfixed toner images are superimposed on the intermediate transfer belt 6 to obtain a full color image. The intermediate transfer belt 6 rotates while carrying the toner image transferred from the photosensitive drum 1 as such. Every rotation of the photosensitive drum 1 after the primary transfer, transfer residual toner is cleaned from the surface of the photosensitive drum 1 in a cleaning unit 11, and the image forming process is repeated.

Further, at the secondary transfer position of the intermediate transfer belt 6 facing the conveyance path of the recording material 7, a secondary transfer roller (transfer portion) 9 is disposed in pressure contact with the side of a surface carrying the toner image of the intermediate transfer belt 6. Further, a counter roller 21 which forms a counter electrode to the secondary transfer roller 9 and to which a bias is applied, is arranged on a back side of the intermediate transfer belt 6 at the secondary transfer position. When the toner image on the intermediate transfer belt 6 is transferred to the recording material 7, a bias having the same polarity as the toner is applied to the counter roller 21 by a secondary transfer bias applying unit 28, and for example, −1000 to −3000 V is applied and a current of −10 to −50 μA flows. The transfer voltage at this time is detected by a transfer voltage detecting unit 29. Further, a cleaning unit (belt cleaner) 12 for removing residual toner on the intermediate transfer belt 6 after the secondary transfer is provided on a downstream side of the secondary transfer position.

The recording material 7 introduced into the secondary transfer position is nipped and conveyed at the secondary transfer position, and at the same time, a constant voltage bias (transfer bias) controlled in a predetermined manner is applied from a secondary transfer bias applying unit 28 to the counter roller 21 of the secondary transfer roller 9. A transfer bias having the same polarity as the toner is applied to the counter roller 21 to collectively transfer full color images of 4 colors (toner images) superimposed on the intermediate transfer belt 6 at a transfer site to the recording material 7, and to form a full color unfixed toner image on the recording material. The recording material 7 to which the toner image is transferred is introduced to a fixing unit (not illustrated) and fixed by heating.

According to the embodiment of the present disclosure, a curable silicone rubber mixture which can provide an elastic layer having a small change in volume resistivity even when a high voltage such as 1,000 V is applied for a long period of time, can be provided. Further, according to the embodiment of the present disclosure, an electrophotographic member which can form a high-quality electrophotographic image stably for a long period of time even on a recording medium having a non-smooth surface such as cardboard and embossed paper, can be obtained. According to still another embodiment of the present disclosure, an electrophotographic image forming apparatus which can form high-quality electrophotographic images stably for a long period of time even on a recording medium having a non-smooth surface, can be obtained.

### EXAMPLES

<Manufacture of Electrophotographic Belt>

### Example 1

(Preparation of Substrate)

The following materials were charged into a biaxial kneader (trade name: PCM30, manufactured by Ikegai Corp.) using a weighing feeder, respectively, and kneaded to obtain these pellets. The cylinder setting temperature of the biaxial kneader was 320° C. at a material charging portion and 360° C. downstream of the cylinder and at a die. A screw rotation speed of the biaxial kneader was 300 rpm, and the material feed rate was 8 kg/h.
Polyetheretherketone (trade name: VICTREXPEEK450G, manufactured by Victrex PLC): 80 parts by mass
Acetylene black (trade name: DENKA BLACK granular product, manufactured by Denka Company Limited): 20 parts by mass

Subsequently, the resulting pellets were subjected to cylindrical extrusion molding to manufacture a substrate having an endless shape. In addition, cylindrical extrusion molding was performed using a single screw extruder (trade name: GT40, manufactured by PLABOR Research Laboratory of Plastics Technology Co., Ltd.) and a cylindrical die having a circular opening portion with a diameter of 300 mm and a gap of 1 mm.

Specifically, pellets were supplied to a single screw extruder at a feed rate of 4 kg/h using a weighing feeder. The cylinder setting temperature of the single screw extruder was 320° C. in a material charging portion and 380° C. downstream of the cylinder and in a circular die. The molten resin discharged from the single screw extruder was extruded from the cylindrical die through a gear pump, and taken up at a speed to a thickness of 60 μm by a cylindrical haul-off machine. The molten resin was cooled and solidified by contacting it with a cooling mandrel provided between the cylindrical die and the cylindrical haul-off machine in the process of being taken up. The solidified resin was cut to have a width of 400 mm with a cylindrical cutting machine mounted on a lower portion of the cylindrical haul-off machine to obtain a substrate having an endless shape.

(Preparation Curable Silicone Rubber Mixture for Forming Elastic Layer)

As the first cation, a first ionic liquid which is a vinyl-modified quaternary ammonium salt having one or more carbon-carbon double bonds and of which the anion is TFSI⁻, was prepared. In addition, the cation has a structure represented by Structural Formula (1-1), wherein R₁₀₁ and R₁₀₂ are a group represented by Structural Formula (1-2) in which p=1, and R₁₀₃ and R₁₀₄ are a methyl group, and the molar mass thereof is 126.2 g/mol. Further, the molar mass of the anion is 280.2 g/mol.

Subsequently, 2.0 parts by mass of the first ionic liquid was added with respect to 100 parts by mass of addition curing type liquid silicone rubber (trade name: TSE3450 A/B, manufactured by Momentive Performance Materials Inc.), and mixed.

Subsequently, as the metal oxide particles having a hydroxyl group on the surface, 2.0 parts by mass of hydrophilic silica particles No. 1 (trade name: AEROSIL90, manufactured by Nippon Aerosil Co., Ltd.) was added, 1.0 part by mass of a black coloring material (trade name: LIM Color 02; manufactured by Shin-Etsu Chemical Co., Ltd.) was added, and the materials were stirred and defoamed using a planetary stirring defoaming apparatus (trade name: HM-500, manufactured by KEYENCE CORPORATION) to obtain an addition curing type liquid silicone rubber mixed solution. In addition, a hydrophilization rate of the hydrophilic silica particles was 52%, and a specific surface area by a BET method was 90±15 (m/g).

Then, after the outer surface of the substrate was subjected to ultraviolet irradiation treatment, a primer (trade name: DY39-051, manufactured by Dow Corning Toray Co., Ltd.) was applied and dried by heating. A substrate having a primer layer formed on the outer surface was attached to a cylindrical core, and a ring nozzle for discharging rubber was attached coaxially with the core. The addition curing type liquid silicone rubber mixture was supplied to a ring nozzle using a liquid feed pump and discharged from a slit, thereby forming a layer of the addition curing type liquid silicone rubber mixture on the substrate. At this time, a relative moving speed and the liquid feed pump discharge amount were adjusted so that the elastic layer after curing had a thickness of 280 μm. The substrate was placed in a heating furnace in a state of being attached to the core and heated to 130° C. for 15 minutes and 180° C. for 60 minutes, and the layer of the addition curing type liquid silicone rubber mixture was cured to form the elastic layer.

(Preparation of Surface Layer)

A fluorine-containing polyurethane resin solution (trade name: Emralon T-861, manufactured by Henkel Japan Ltd.) in which polytetrafluoroethylene was dispersed in a polyurethane dispersion, was prepared. Then, after the outer surface of the elastic layer was subjected to hydrophilization treatment by excimer UV irradiation, the urethane resin solution was applied using a spray gun (trade name: W-101, manufactured by ANEST IWATA Corporation) while the layer was fitted into the core and rotated at 200 rpm. After the application, the layer was placed in a heating furnace at 130° C. and cured for 30 minutes. Thus, the electrophotographic belt No. 1 having the surface layer having a thickness of 3 μm on the elastic layer, was obtained.

### Example 2

An electrophotographic belt No. 2 was manufactured in the same manner as in Example 1, except that in the preparation of the curable silicone rubber mixture for forming an elastic layer in Example 1, the silica particles No. 1 was changed to hydrophilic silica particles No. 2 having a hydrophilization rate of 96% and a BET specific surface area of 200±25 (m/g) (trade name: AEROSIL200, manufactured by Nippon Aerosil Co., Ltd.).

### Example 3

An electrophotographic belt No. 3 was manufactured in the same manner as in Example 1, except that in the preparation of the curable silicone rubber mixture for forming an elastic layer in Example 1, the silica particles No. 1 was changed to hydrophilic silica No. 3 having a hydrophilization rate of 98% and a BET specific surface area of 380±30 (m/g) (trade name: AEROSIL380, manufactured by Nippon Aerosil Co., Ltd.).

### Example 4

An electrophotographic belt No. 4 was manufactured in the same manner as in Example 3, except that in the preparation of the curable silicone rubber mixture for forming an elastic layer in Example 3, an amount of the first ionic liquid added was changed to 0.5 parts by mass.

### Example 5

An electrophotographic belt No. 5 was manufactured in the same manner as in Example 3, except that in the preparation of the curable silicone rubber mixture for forming an elastic layer in Example 3, an amount of the first ionic liquid added was changed to 10.0 parts by mass.

### Example 6

An electrophotographic belt No. 6 was manufactured in the same manner as in Example 3, except that in the preparation of the curable silicone rubber mixture for forming an elastic layer in Example 3, an amount of the hydrophilic silica added was changed to 0.2 parts by mass.

### Example 7

An electrophotographic belt No. 7 was manufactured in the same manner as in Example 3, except that in the preparation of the curable silicone rubber mixture for forming an elastic layer in Example 3, an amount of the hydrophilic silica added was changed to 5.0 parts by mass.

### Example 8

An electrophotographic belt No. 8 was manufactured in the same manner as in Example 1, except that in the preparation of the elastic layer in Example 1, the silica particles No. 1 was changed to hydrophilic alumina particles having a hydrophilization rate of 67% and a BET specific surface area of 130±20 (m/g) (trade name: AEROXIDE Alu130, manufactured by Nippon Aerosil Co., Ltd.).

### Comparative Example 1

An electrophotographic belt No. 9 was manufactured in the same manner as in Example 4, except that in the preparation of the curable silicone rubber mixture for forming an elastic layer in Example 4, the cation was changed to a tetramethylammonium cation.

### Example 9

As the second cation, an ionic liquid which is in a quaternary phosphonium salt modified with a dimethylsiloxane chain of which the anion was TFSI⁻ as in the first ionic liquid, was prepared. In addition, the action has the structure represented by Structural Formula (2-2) wherein R₂₀₁ to R₂₀₃ are an alkyl group having 4 carbon atoms, R₂₀₄ is an alkyl group having 1 carbon atom, R₂₀₅ is an epoxy group, R₂₀₆ is a hydroxyl group, and R₂₀₇ is an alkylene group having 3 carbon atoms, and has a molar mass of 569.3 g/mol.

An electrophotographic belt No. 10 was manufactured in the same manner as in Example 3, except that in the preparation of the curable silicone rubber mixture for forming an elastic layer in Example 3, 0.9 parts by mass of the second ionic liquid was further added. In the total amount of the first ionic liquid and the second ionic liquid added, the molar amount of the second cation to the molar amount of the first cation was 46%.

### Example 10

An electrophotographic belt No. 11 was manufactured in the same manner as in Example 9, except that in the preparation of the curable silicone rubber mixture for forming an elastic layer in Example 3, an amount of the first ionic liquid added was changed to 7.0 parts by mass and 3.0 parts by mass of the second ionic liquid was further added. In the total amount of the first ionic liquid and the second ionic liquid added, the molar amount of the second cation to the molar amount of the first cation was 44%.

<Evaluation>

The electrophotographic belts Nos. 1 to 11 were evaluated as follows. An initial volume resistivity and a volume resistivity after applying 1000 V of direct voltage were measured. Further, a value was obtained by the calculation of dividing an absolute value of a difference between the initial volume resistivity and the volume resistivity after applying voltage by the initial volume resistivity and multiplying the resulting value by 100, as a change rate of the volume resistivity.

Further, the image when each of the electrophotographic belts was used as the intermediate transfer belt to form the electrophotographic image was evaluated.

[Measurement of Volume Resistivity (Initial)]

For each of the electrophotographic belts Nos. 1 to 11 obtained in each of the Examples and Comparative Example, the volume resistivity before being used in formation of the electrophotographic image was measured as follows.

That is, the value of the volume resistivity (initial) was defined as an average value when measured at 58 points at intervals of 20 mm for each of the electrophotographic belts having a circumference of 1147 mm.

The measurement of the volume resistivity was performed using a high resistivity meter (trade name: HIRESTA MCP-HT450, manufactured by Mitsubishi Chemical Analytech Co., Ltd.) by a double electrode method. A value obtained when “UR probe” was used as the electrode and a voltage of 1000 V was applied for 10 seconds was used. In addition, the measurement of the volume resistivity was performed under the environment of a temperature of 25° C. and a relative humidity of 55%.

Further, for each of the electrophotographic belts, a ratio of a minimum value and a maximum value (maximum value/minimum value) of the volume resistivity measured at 58 points was calculated, and used as an index of uniformity of the volume resistivity of each of the electrophotographic belts.

[Measurement of Volume Resistivity after Forming Electrophotographic Image and Image Evaluation]

Instead of the intermediate transfer belt mounted in a full color electrophotographic image forming apparatus (trade name: imagePRESS C800, manufactured by Canon Inc.), the electrophotographic belt according to each of the Examples and the Comparative Example was mounted as the intermediate transfer belt. Then, a cyan solid image was output on A4 size plain paper (trade name: CS-680A4, manufactured by Canon Inc.). In addition, in the image formation, cyan and magenta developers mounted on the print cartridge of the electrophotographic image forming apparatus were used. Further, the image was output under the environment of normal temperature (a temperature of 25° C. and relative humidity of 55%). In addition, in the full color electrophotographic image forming apparatus, the first transfer unit includes a transfer roller disposed oppositely to the electrophotographic photosensitive member through the intermediate transfer belt, and a first transfer voltage was 1000 to 3000 V, and a second transfer voltage was 1000 V.

100 sheets of images were output under the above output conditions. Subsequently, the paper was changed to B5 size plain paper (trade name: CS-680B5, manufactured by Canon Inc.) and 30,000 sheets were continuously output. Further, subsequently, the paper was changed to A4 size plain paper (trade name: CS-680A4, manufactured by Canon Inc.), and one sheet of image was output. Thereafter, the intermediate transfer belt to be evaluated was removed from the full color electrophotographic image forming apparatus, and the volume resistivity was measured by the same method as described above. The resulting values were arithmetically averaged to calculate the volume resistivity (after voltage application).

Further, a value was obtained by the calculation of dividing an absolute value of a difference between volume resistivity (initial) and the volume resistivity (after voltage application) by the volume resistivity (initial) and multiplying the resulting value by 100, as a change rate of the volume resistivity.

Furthermore, in the electrophotographic image formation apparatus described above, a cyan solid image formed on A4 size plain paper which was output on 100 sheets (hereinafter, referred to as “initial image”) and a cyan solid image formed on A4 size paper which was finally output (hereinafter, referred to as “final image”) were visually observed, and evaluated by the following criteria.

(Image Evaluation Criteria)

Rank A: unevenness is not recognized at all.

Rank B: some minor unevenness is recognized.

Rank C: unevenness is recognized in about 20% of the observed image.

Rank D: unevenness is recognized over a half or more of the observed image.

The above evaluation results are shown in the following Table 1.

TABLE 1

| | | | Volume resistivity | | | | | |
|---|---|---|---|---|---|---|---|---|
| | | | (Ω · cm) | | | | | |
| | | | | Initial maximum | Average value | Change rate of | | |
| | | Electrophotographic | Initial average | value/minimum | after voltage | volume | Image evaluation rank | |
| | | belt No. | value | value | application | resistivity | Initial image | Final image |
| Example | 1 | 1 | 4.0 × 10¹⁰ | 1.56 | 5.2 × 10¹⁰ | 30.0% | A | A |
| | 2 | 2 | 9.8 × 10⁹ | 1.45 | 1.3 × 10¹⁰ | 32.7% | A | A |
| | 3 | 3 | 1.2 × 10¹⁰ | 1.51 | 1.7 × 10¹⁰ | 41.7% | A | A |
| | 4 | 4 | 1.2 × 10¹¹ | 1.72 | 1.8 × 10¹¹ | 50.0% | A | A |
| | 5 | 5 | 5.3 × 10⁹ | 1.32 | 6.1 × 10⁹ | 15.1% | A | A |
| | 6 | 6 | 7.6 × 10¹⁰ | 1.83 | 9.9 × 10¹⁰ | 30.3% | A | A |
| | 7 | 7 | 2.7 × 10¹⁰ | 1.45 | 3.6 × 10¹⁰ | 33.3% | A | A |
| | 8 | 8 | 1.0 × 10¹¹ | 1.69 | 1.5 × 10¹¹ | 50.0% | A | A |
| | 9 | 10 | 9.8 × 10⁹ | 1.15 | 1.4 × 10¹⁰ | 42.9% | A | A |
| | 10 | 11 | 4.3 × 10⁹ | 1.09 | 5.4 × 10⁹ | 25.6% | A | A |

| | | | | | | | |
|---|---|---|---|---|---|---|---|
| Comparative | 9 | 6.7 × 10⁹ | 1.93 | 3.2 × 10¹⁰ | 377.6% | A | C |
| Example 1 | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-224158, filed Nov. 29, 2018, and Japanese Patent Application No. 2019-201063, filed Nov. 5, 2019, which are hereby incorporated by reference herein in their entirety.

What is claimed is:

1. A curable silicone rubber mixture comprising: a curable silicone rubber, a cation, an anion and metal oxide particles, wherein
the cation includes a first cation having one or more carbon-carbon double bonds in a molecular thereof,
the metal oxide particles have surfaces whose hydrophilization rate is 0.50 or more.

2. The curable silicone rubber mixture according to claim 1, wherein the metal oxide particle is alumina particle or silica particle.

3. The curable silicone rubber mixture according to claim 2, wherein the silica particles have surfaces whose hydrophilization rate is 0.51 or more and 0.98 or less, wherein the hydrophilization rate is defined as a value calculated by dividing an absorbance at 7300 cm⁻¹ representing Si—OH by an absorbance at 4500 cm⁻¹ representing SiO₂ in an IR spectrum on a surface of the silica particle.

4. The curable silicone rubber mixture according to claim 2, wherein the alumina particles have surfaces whose hydrophilization rate is 0.50 or more, wherein the hydrophilization rate is defined as a value calculated by dividing an absorbance at 3690 cm⁻¹ representing Al—OH by an absorbance at 7425 cm⁻¹ representing Al₂O₃ in an IR spectrum on a surface of the alumina particles.

5. The curable silicone rubber mixture according to claim 1, wherein the metal oxide particles are comprised at 0.1 parts by mass or more and 30.0 parts by mass or less, with respect to 100 parts by mass of the curable silicone rubber.

6. The curable silicone rubber mixture according to claim 1, wherein the first cation has a structure represented by the following Structural Formula (1-1): 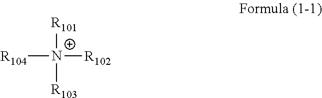
wherein R₁₀₁ to R₁₀₄ independently of each other represent a group represented by Structural Formula (1-2) and a group selected from the group consisting of alkyl groups having 1 to 4 carbon atoms, but at least one of R₁₀₁ to R₁₀₄ is a group represented by Structural Formula (1-2): 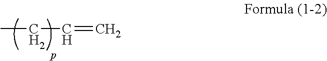
wherein p is an integer of 1 or more and 4 or less.

7. The curable silicone rubber mixture according to claim 1, being free of an electronic conductive agent.

8. The curable silicone rubber mixture according to claim 1, further comprising an electronic conductive agent, wherein the content of the electronic conductive agent is 0.1% by mass or less, with respect to a total amount of the curable silicone rubber mixture.

9. The curable silicone rubber mixture according to claim 1, wherein the cation further comprises a second cation having a dimethylsiloxane chain.

10. The curable silicone rubber mixture according to claim 9, wherein the second cation has a cation structure selected from the group consisting of quaternary ammonium, phosphonium, sulfonium, imidazolium, pyrrolidinium, piperidinium, pyridinium, and morpholinium.

11. The curable silicone rubber mixture according to claim 9, wherein the second cation has one of structures represented by Structural Formulae (2-1) to (2-4): 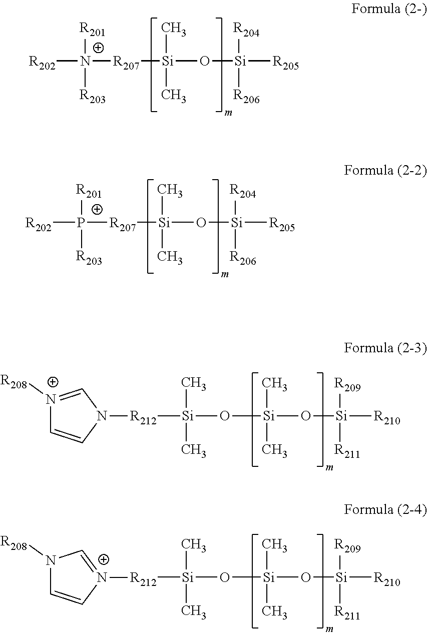
wherein in Structural Formulae (2-1) and (2-2), R₂₀₁ to R₂₀₃ independently of each other represent an alkyl group having 1 to 10 carbon atoms, an alkoxy group having 1 to 10 carbon atoms, a hydroxyl group, a benzyl group, or a carboxyl group, R₂₀₄ to R₂₀₆ independently of each other represent an alkyl group having 1 to 10 carbon atoms, a hydroxyl group, an epoxy group, or a carboxyl group, R₂₀₇ represents an alkylene group having 1 to 20 carbon atoms which may have a substituent, the alkylene group may have a structure via a group selected from the group consisting of -Ph-, —O—, —C(═O)—, —C(═O)—O—, or —C(═O)—NR—(R represents an alkyl group having 1 to 6 carbon atoms), and m is an integer of 1 or more and 150 or less, and
in Structural Formulae (2-3) and (2-4), R₂₀₈ represents an alkyl group having 1 to 10 carbon atoms, an alkoxy group having 1 to 10 carbon atoms, a benzyl group, or a carboxyl group, R₂₀₉ to R₂₁₁ independently of each other represent an alkyl group having 1 to 10 carbon atoms, R₂₁₂ represents an alkylene group having 1 to 20 carbon atoms which may have a substituent, the alkylene group may have a structure via a group selected from the group consisting of -Ph-, —O—, —C(═O)—, —C(═O)—O—, or —C(═O)—NR—(R represents an alkyl group having 1 to 6 carbon atoms), and m represents an integer of 1 or more and 150 or less.

12. The curable silicone rubber mixture according to claim 1, wherein the anion is at least one selected from the group consisting of AlCl₄⁻, Al₂Cl₇⁻, NO₃⁻, BF₄⁻, PF₆⁻, CH₃COO⁻, CF₃COO⁻, CF₃SO₃⁻, (CF₃SO₂)₃C⁻, AsF₆⁻, SbF₆⁻, F(HF)n⁻, CF₃CF₂CF₂CF₂SO₃⁻, (CF₃CF₂SO₂)₂N⁻, CF₃CF₂CF₂COO⁻, and (CF₃SO₂)₂N⁻.

13. The curable silicone rubber mixture according to claim 1, wherein a total amount of the cation and the anion is 0.01 parts by mass or more and 10 parts by mass or less, with respect to 100 parts by mass of the curable silicone rubber.

14. An electrophotographic member comprising: a substrate and an elastic layer on the substrate, wherein
the elastic layer includes a cured product of a curable silicone rubber mixture,
the curable silicone rubber mixture includes a curable silicone rubber, a cation, an anion, and metal oxide particles, wherein the cation includes a first cation having one or more carbon-carbon double bonds in a molecular thereof, and the metal oxide particles have surfaces whose hydrophilization rate is 0.50 or more.

15. The electrophotographic member according to claim 14, wherein a volume resistivity of the elastic layer is 1.0×10⁸ Ω·cm to 2.0×10¹¹ Ω·cm.

16. The electrophotographic member according to claim 14, being an electrophotographic belt having an endless shape.

17. An electrophotographic image forming apparatus comprising an intermediate transfer member, wherein
the intermediate transfer member includes an electrophotographic member including a substrate and an elastic layer on the substrate,
the elastic layer includes a cured product of a curable silicone rubber mixture,
the curable silicone rubber mixture includes a curable silicone rubber, a cation, an anion, and metal oxide particles, wherein the cation includes a first cation having one or more carbon-carbon double bonds in a molecular thereof, the metal oxide particles have surfaces whose hydrophilization rate is 0.50 or more.
